(19) United States
(12) Patent Application Publication
(10) Pub. No.: US 2025/0307747 A1
(43) Pub. Date: Oct. 2, 2025

(54) SYSTEM, METHOD, APPARATUS, AND COMPUTER PROGRAM FOR AUTOMATICALLY GENERATING NATURAL LANGUAGE-BASED BUSINESS PROCESS

(71) Applicant: SAMSUNG SDS CO., LTD., Seoul (KR)

(72) Inventor: Kyungho Cho, Seoul (KR)

(73) Assignee: SAMSUNG SDS CO., LTD., Seoul (KR)

(21) Appl. No.: 19/085,918

(22) Filed: Mar. 20, 2025

(30) Foreign Application Priority Data
Mar. 29, 2024 (KR) 10-2024-0043216
May 28, 2024 (KR) 10-2024-0069627

(51) Int. Cl. G06Q 10/0633; G06F 40/40

(52) U.S. Cl. CPC G06Q 10/0633; G06F 40/40

(57) ABSTRACT

The disclosure relates to a natural language-based business process auto-generating system, method, apparatus, and computer program. More specifically, a method for generating a business process configured to include one or more unit elements to perform a given target business using a computing device may include: configuring a first prompt, based on input text including a description of the target business; producing types and connection sequences of one or more unit elements constituting the business process using an artificial intelligence model, based on the first prompt; and generating the business process corresponding to the target business, based on the types and connection sequences of the one or more unit elements.

### CROSS-REFERENCE TO RELATED APPLICATION(S)

This application is based on and claims priority under 35 U.S.C. 119 to Korean Patent Applications No. 10-2024-0043216, filed on Mar. 29, 2024 and No. 10-2024-0069627, filed on May 28, 2024, in the Korean Intellectual Property Office, the disclosure of which is herein incorporated by reference in its entirety.

### BACKGROUND OF THE INVENTION

### 1. Field of the Invention

The disclosure relates to a system, method, apparatus, and computer program for automatically generating natural language-based business processes and, more specifically, to a system, method, apparatus, and computer program for automatically generating natural language-based business processes capable of producing one or more process symbols through analysis of a target business written in natural language and automatically generating business processes, based on the same.

### 2. Description of the Prior Art

In the conventional business process management system (BPMS), business processes are designed by generally combining various types of symbols on the basis of the business process modeling and notation (BPMN), and further, the management of the business processes is performed using this.

However, in the conventional business process management system (BPMS), the worker must directly identify various symbols defined in the BPMN, etc., and manually design and implement the business processes to be generated using a given user interface (UI). Accordingly, it may take considerable time and cost for workers lacking related knowledge and experience to generate the business processes because they must identify the meanings and usage of various symbols and also learn how to use the user interface (UI).

Furthermore, if the workers wish to generate necessary business processes by modifying the business processes designed by other users, they could experience even greater difficulties in the process of interpreting and modifying the pre-designed business processes.

Accordingly, there is a need for a method that allows workers to more efficiently design the business processes they want, and furthermore, to easily modify pre-designed business processes to generate business processes suitable for them, but an appropriate solution has not yet been presented.

### SUMMARY OF THE INVENTION

The disclosure has been made in order to solve the above-mentioned problems in the prior art and an aspect of the disclosure is to provide a system, method, apparatus, and computer program for automatically generating a business process enabling workers to efficiently design the business process they desire even if they lack related knowledge and experience.

In addition, the disclosure is to provide a system, method, apparatus, and computer program for automatically generating a business process enabling workers to easily modify a pre-designed business process to generate a business process suitable for them.

Furthermore, the disclosure is to provide a system, method, apparatus, and computer program for automatically generating a business process capable of effectively reducing the cost and time required for workers to generate a business process by simplifying the process of designing the business process.

The technical problems to be solved in the disclosure are not limited to the technical problems mentioned above, and other technical problems that are not mentioned will be clearly understood by those skilled in the art to which the disclosure belongs from the description in this specification.

According to the first aspect of the disclosure, a method for generating a business process configured to include one or more unit elements to perform a given target business using a computing device may include: configuring a first prompt, based on input text including a description of the target business; producing types and connection sequences of one or more unit elements constituting the business process using an artificial intelligence model, based on the first prompt; and generating the business process corresponding to the target business, based on the types and connection sequences of the one or more unit elements.

Here, in the configuring of the first prompt, the first prompt may be configured using a system prompt configured to include information about a plurality of types of unit elements and a user prompt configured based on the input text.

In addition, the system prompt may include first information about the types and characteristics of the unit elements, second information about rules for configuring the business process, based on one or more unit elements, and third information about a format of a response generated in the artificial intelligence model.

In addition, r prompt may include fourth information obtained, when generating the business process by modifying a pre-generated second business process, by converting the second business process into a data format capable of being processed by the artificial intelligence model, and fifth information configured based on the input text.

In this case, the fourth information may include information about one or more unit elements constituting the second business process, which is converted into a JSON type. In addition, in the configuring of the first prompt, the first prompt may be generated by reflecting, together with the input text, input information specifying connection positions to which one or more unit elements are to be added in the second business process, and in the generating of the business process, the business process may be generated by adding one or more unit elements to the connection positions.

In addition, in the producing of the types and connection sequences 4 the unit elements, a response generated in the artificial intelligence model may include a list of one or more unit elements constituting the business process.

In this case, the list of one or more unit elements may include information about the types of respective unit elements and the connection sequences of respective unit elements.

In addition, in the generating of the business process, the business process may be generated by sequentially configuring and adding each unit element, based on the types and connection sequences of the one or more unit elements. Furthermore, the method may further include automatically performing the target business using the generated business process.

According to the second aspect of the disclosure, an apparatus for generating a business process configured to include one or more unit elements to perform a given target business may include: a processor; and a memory, wherein the memory may include instructions configured to, when executed by the processor, cause the apparatus to implement specific operations, and the specific operations may include: configuring a first prompt, based on input text including a description of the target business; producing types and connection sequences of one or more unit elements constituting the business process using an artificial intelligence model, based on the first prompt; and generating the business process corresponding to the target business, based on the types and connection sequences of the one or more unit elements.

Here, in the configuring of the first prompt, the first prompt may be configured using a system prompt configured to include information about a plurality of types of unit elements and a user prompt configured based on the input text.

In addition, the system prompt may include first information about the types and characteristics of the unit elements, second information about rules for configuring the business process, based on one or more unit elements, and third information about a format of a response generated in the artificial intelligence model.

In addition, the user prompt may include fourth information obtained, when generating the business process by modifying a pre-generated second business process, by converting the second business process into a data format capable of being processed by the artificial intelligence model, and fifth information configured based on the input text.

In this case, the fourth information may include information about one or more unit elements constituting the second business process, which is converted into a JSON type. In addition, in the configuring of the first prompt, the first prompt may be generated by reflecting, together with the input text, input information specifying connection positions to which one or more unit elements are to be added in the second business process, and in the generating of the business process, the business process may be generated by adding one or more unit elements to the connection positions.

In addition, in the producing of the types and connection sequences the unit elements, a response generated in the artificial intelligence model may include a list of one or more unit elements constituting the business process.

In this case, the list of one or more unit elements may include information about the types of respective unit elements and the connection sequences of respective unit elements.

In addition, in the generating of the business process, the business process may be generated by sequentially configuring and adding each unit element, based on the types and connection sequences of the one or more unit elements.

According to the third aspect of the disclosure, a computer-readable storage medium storing instructions configured to cause, when executed by a processor, an apparatus, including the processor and generating a business process configured to include one or more unit elements to perform a given target business, to implement specific operations, wherein the specific operations may include: configuring a first prompt, based on input text including a description of the target business; producing types and connection sequences of one or more unit elements constituting the business process using an artificial intelligence model, based on the first prompt; and generating the business process corresponding to the target business, based on the types and connection sequences of the one or more unit elements.

Accordingly, in the business process auto-generation system, method, apparatus, and computer program according to an embodiment of the disclosure, workers are able to efficiently design desired business processes even if they lack related knowledge and experience.

In addition, in the business process auto-generation system, method, apparatus, and computer program according to an embodiment of the disclosure, workers are able to easily modify a pre-designed business process to generate business processes suitable for them.

In addition, in the business process auto-generation system, method, apparatus, and computer program according to an embodiment of the disclosure, it is possible to effectively reduce the cost and time required for workers to generate a business process by simplifying the process of designing the business process.

The effects obtainable from the disclosure are not limited to the effects mentioned above, and other effects that are not mentioned will be clearly understood by those skilled in the art to which the disclosure belongs from the description in this specification.

### BRIEF DESCRIPTION OF THE DRAWINGS

The attached drawings, which are included as part of the detailed description to help understanding of the disclosure, provide embodiments of the disclosure and explain the technical ideas of the disclosure together with the detailed description.

FIG. 1 is a diagram illustrating the configuration of a business process generating system according to an embodiment of the disclosure.

FIG. 2 is a flowchart illustrating a business process generating method according to an embodiment of the disclosure.

FIGS. 3 and 4 are diagrams illustrating a user input screen according to an embodiment of the disclosure.

FIG. 5 is a diagram illustrating the configuration and operation of a business process generating apparatus according to an embodiment of the disclosure.

FIGS. 6 and 7 are diagrams illustrating a system prompt and a user prompt according to an embodiment of the disclosure.

FIG. 8 is a flowchart illustrating calling of an artificial intelligence model according to an embodiment of the disclosure.

FIGS. 9 and 10 are diagrams illustrating responding of an artificial intelligence model according to an embodiment of the disclosure.

FIG. 11 is a flowchart illustrating a process of generating a business process based on a response of an artificial intelligence model according to an embodiment of the disclosure.

FIG. 12 is a diagram illustrating a business process generated according to an embodiment of the disclosure.

FIG. 13 is a diagram illustrating a BPMN XML document generated according to an embodiment of the disclosure.

FIG. 14 is a flowchart specifically illustrating a business process generating method according to an embodiment of the disclosure.

FIG. 15 is a diagram illustrating a user input screen according to an embodiment of the disclosure.

FIG. 16 is a diagram illustrating the configuration of a computing device for generating a business process according to an embodiment of the disclosure.

### DETAILED DESCRIPTION OF THE EXEMPLARY EMBODIMENTS

Hereinafter, the embodiments disclosed in this specification will be described in detail with reference to the attached drawings. The purpose, specific advantages, and novel features of the disclosure will become more apparent from the following detailed description and preferred embodiments associated with the attached drawings.

Prior to describing the disclosure, the terms or words used in this specification and claims have been appropriately defined by the inventor as meanings and concepts to explain the disclosure in the best possible way, and should be interpreted as meanings and concepts that are consistent with the technical idea of the disclosure, which are used to explain the embodiments, instead of limiting the disclosure.

Regardless of the reference numerals, identical or similar components will be assigned the same reference numerals, and redundant descriptions thereof will be omitted. The terms “module” and “unit” used for components in the following description are assigned or used interchangeably in consideration of the ease of drafting the specification, and do not have distinct meanings or roles in themselves, and may indicate software or hardware components.

In describing the components of the disclosure, a singular expression should be understood to include a plurality of components, unless otherwise mentioned. In addition, the terms “first,” “second,” etc. are used to identify one component from another component, and the components are not limited to the terms. In addition, in the case where a component is connected to another component, it indicates that a third component may be connected between the two components.

In addition, when describing the embodiments disclosed in this specification, a specific description of a related known technology, which may obscure the subject matter of the embodiments disclosed in this specification, will be omitted. In addition, the attached drawings are only intended to facilitate easy understanding of the embodiments disclosed in this specification, and the technical ideas disclosed in this specification are not limited to the attached drawings, and should be understood to encompass all modifications, equivalents, or substitutes included in the scope of the disclosure.

Hereinafter, exemplary embodiments of a natural language-based business process auto-generating system, method, apparatus, and computer program according to the disclosure will be described in detail with reference to the attached drawings.

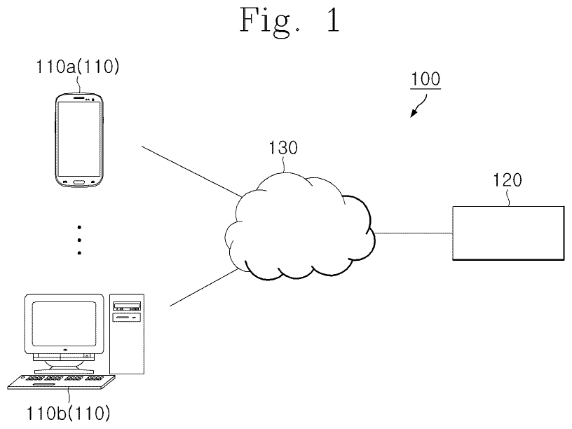

FIG. 1 illustrates the configuration and operation of a business process generating system 100 according to an embodiment of the disclosure. As shown in FIG. 1, the business process generating system 100 according to an embodiment of the disclosure may be configured to include one or more user terminals 110a and 110b and a business process generating apparatus 120 that is interlinked with the terminals 110a and 110b and generates and provides a business process for a target business upon request by a user.

In this case, various terminals such as personal computers (PCs), laptop PC, tablet PCs, smartphones, PDAS, and the like may be used as the terminals 110a and 110b to allow users to input text requesting the generation of business processes, or to display and provide generated business processes, but the disclosure is not necessarily limited thereto, and various devices such as servers capable of providing information necessary for the generation of business processes may be used as the terminals 110a and 110b.

In addition, the business process generating apparatus 120 may be implemented using one or more servers, but the disclosure is not necessarily limited thereto, and it may also be configured in various forms such as configuring using personal computer processing devices such as desktop computers, laptops, tablets, or smartphones, configuring based on a cloud system, or configuring using a dedicated device.

Furthermore, the terminals 110a and 110b and the business process generating apparatus 120 may be implemented in an integrated form using the same server or the like.

In addition, a wired network and a wireless network may be used as a network 130 connecting the terminals 110a and 110b and the business process generating apparatus 120 in FIG. 1, and specifically, the network may include various communication networks such as a local area network (LAN), a metropolitan area network (MAN), and a wide area network (WAN). In addition, the network 130 may include the well-known World Wide Web (WWW). Furthermore, the network 130 may also be implemented using a data bus configured to transmit and receive data.

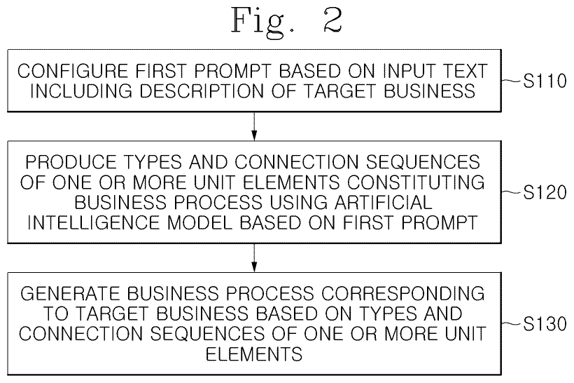

In addition, FIG. 2 illustrates a flowchart of a business process generating method according to an embodiment of the disclosure.

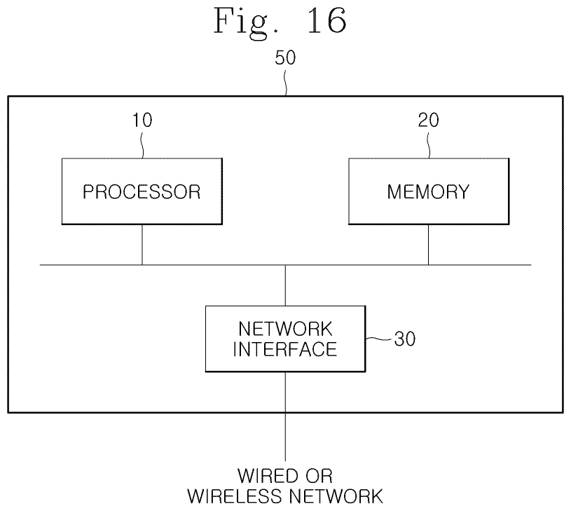

Here, the method illustrated in FIG. 2 may be performed by, for example, the business process generating apparatus 120, and the business process generating apparatus 120 may be implemented to include a computing device 50 in FIG. 16 and a description to be made later with reference to FIG. 16. For example, the business process generating apparatus 120 may be provided with a processor 10, and the processor 10 may perform instructions configured to implement operations for generating a business process to perform a given target business.

More specifically, as shown in FIG. 2, a business process generating method according to an embodiment of the disclosure is a method for generating a business process configured to include one or more unit elements to perform a given target business using a computing device 50, which may include: a step S110 of configuring a first prompt, based on input text including a description of the target business; a step S120 of producing types and connection sequences of one or more unit elements constituting the business process using an artificial intelligence model, based on the first prompt; and a step S130 of generating the business process corresponding to the target business, based on the types and connection sequences of the one or more unit elements.

Here, in the step S110 of configuring the first prompt, the first prompt may be configured using a system prompt configured to include information about a plurality of types of unit elements and a user prompt configured based on the input text.

In addition, the system prompt may include first information about the types and characteristics of the unit elements, second information about rules for configuring the business process, based on one or more unit elements, and third information about a format of a response generated in the artificial intelligence model.

In addition, the user prompt may include fourth information obtained, when generating the business process by modifying a pre-generated second business process, by converting the second business process into a data format capable of being processed by the artificial intelligence model, and fifth information configured based on the input text.

In this case, the fourth information may include information about one or more unit elements constituting the second business process, which is converted into a JSON type.

In addition, in the step S110 of configuring the first prompt, the first prompt may be generated by reflecting, together with the input text, input information specifying connection positions to which one or more unit elements are to be added in the second business process, and in the step S130 of generating the business process, the business process may be generated by adding one or more unit elements to the connection positions.

In addition, in the step S120 of producing the types and connection sequences of the unit elements, a response generated in the artificial intelligence model may include a list of one or more unit elements constituting the business process.

In this case, the list of one or more unit elements may include information about the types of respective unit elements and the connection sequences of respective unit elements.

In addition, in the step S130 of generating the business process may be generated by process, the business sequentially configuring and adding each unit element, based on the types and connection sequences of the one or more unit elements.

Furthermore, the method may further include automatically performing the target business using the generated business process.

Accordingly, in the natural language-based business process auto-generation system, method, apparatus, and computer program according to an embodiment of the disclosure, workers are able to efficiently design desired business processes, even if they lack related knowledge and experience, and easily modify a pre-designed business process to generate business processes suitable for them, and furthermore, it is possible to effectively reduce the cost and time required to generate a business process by simplifying the process of designing the business process.

Hereinafter, the configuration and operation of a natural language-based business process auto-generating system, method, apparatus, and computer program according to an embodiment of the disclosure will be described in more detail with reference to the respective drawings.

First, in step S110, a computing device 50 such as the business process generating apparatus 120 configures a first prompt, based on input text including a description of a target business.

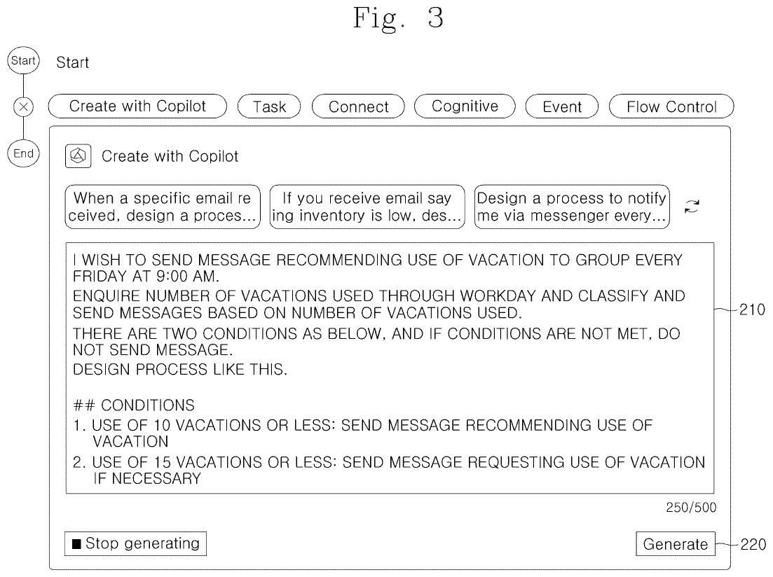

As a more specific example, as shown in FIG. 3, if a user wishes to generate a business process for performing a vacation recommendation message processing business (target business), the user may enter input text 210 describing the target business through a user interface (UI) provided through a user terminal 110 or the like.

In this case, as shown in FIG. 3, the input text 210 may describe the content, conditions, and characteristics of the target business in natural language, but the disclosure is not necessarily limited to this.

Next, the user may generate a business process based on the input text including the description of the target business using a business process generation button 220 provided in the user interface (UI).

In addition, if the user wishes to modify a pre-generated second business process to generate a business process for the target business, the user may input information about the second business process or information capable of specifying the second business process, along with the input text 210, through the user interface (UI) provided through the user terminal 110 or the like.

Here, the pre-generated second business process may be a business process generated through past working, and may also be a business process that is being produced or modified during current working.

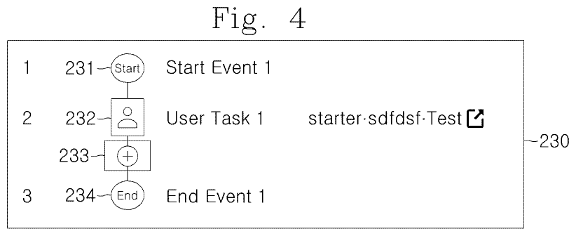

Furthermore, as shown in FIG. 4, the user may also input information about connection positions 233 to which one or more unit elements are to be added in the second business process 230 in a manner such as selecting the connection positions 233 to which one or more unit elements are to be added from the second business process 230.

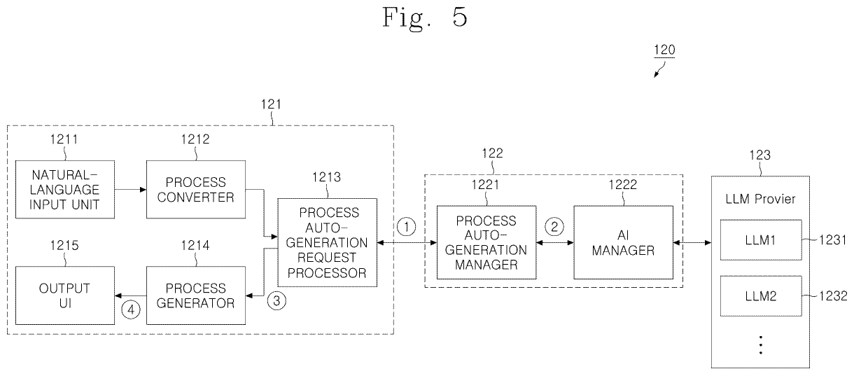

In this regard, FIG. 5 illustrates a specific configuration and operation of the business process generating apparatus 120 according to an embodiment of the disclosure.

Referring to FIG. 5, the business process generating apparatus 120 may be configured to include a front-end block 121 that provides an interface to the user and a back-end block 122 that processes user requests using an artificial intelligence model, but this is only an embodiment according to the disclosure, and the disclosure is not necessarily limited thereto, and the business process generating apparatus 120 may be implemented in various forms, such as the front-end block 121 and the back-end block 122 being implemented in an integrated form using a single server.

More specifically, the front-end block 121 may be configured to include a natural-language input unit 1211, a process converter 1212, a process auto-generation request processor 1213, a process generator 1214, and an output interface 1215, and the front-end block 121 may be configured in various forms by, for example, excluding some of the above components or combining two or more components.

In this case, the natural-language input unit 1211 may receive input text 210 that the user inputs in the form of natural language through the user terminal 110, and may also receive information about the pre-generated second business process, which is input by the user.

In this case, as shown in FIG. 4, the second business process 230 may be configured to include one or more unit elements 231, 232, and 234.

More specifically, the second business process 230 may be configured as one or more unit elements connected in a predetermined sequence, which are various types of symbols or symbol cards (hereinafter collectively referred to as symbols) based on the business process modeling and notation (BPMN), but the disclosure is not necessarily limited thereto.

However, as shown in FIG. 4, since the second business process 230 may be expressed in the form of an image in which symbols are combined, it may be difficult for an artificial intelligence model, which performs processing based on text, to efficiently process the same, so the process converter 1212 may convert the second business process 230 into a data form, such as text, capable of being processed by the artificial intelligence model and summarize it.

As a more specific example, the process converter 1212 may convert information about one or more unit elements 231, 232, and 234 constituting the second business process 230 into a JSON type and produce summarized information.

Accordingly, the artificial intelligence model may generate a business process for performing the target business by modifying the second business process 230, based on the input text 210 describing the target business.

On the other hand, in the case where a business process is newly generated based on the input text 210 input by the user, the process converter 1212 may generate a business process for performing the target business based on the input text 210 without converting the second business process 230.

Next, the process auto-generation request processor 1213 may provide data input from the user, such as the input text 210, and the data converted from the second business process 230 to the back-end block 122, thereby requesting generation of a business process (\textcircled{1} in FIG. 5).

In this case, as shown in FIG. 5, the back-end block 122 may be configured to include a process auto-generation manager 1221 and an artificial intelligence model manager 1222, and it is also possible to configure the back-end block 122 in various forms by, for example, excluding some of the above components or combining two or more components.

Next, the process auto-generation manager 1221 may configure a first prompt to generate a business process corresponding to the target business using an artificial intelligence model, such as a large language model (LLM), based on the data received from the process auto-generation request processor 1213.

In this case, the business process, like the second business process 230 illustrated in FIG. 4, may be configured as one or more unit elements connected in a predetermined sequence, which are various types of symbols based on the business process modeling and notation (BPMN), but the disclosure is not necessarily limited thereto.

Here, the process auto-generation manager 1221 may configure the first prompt using a system prompt configured to include information about multiple types of unit elements and a user prompt configured based on the input text.

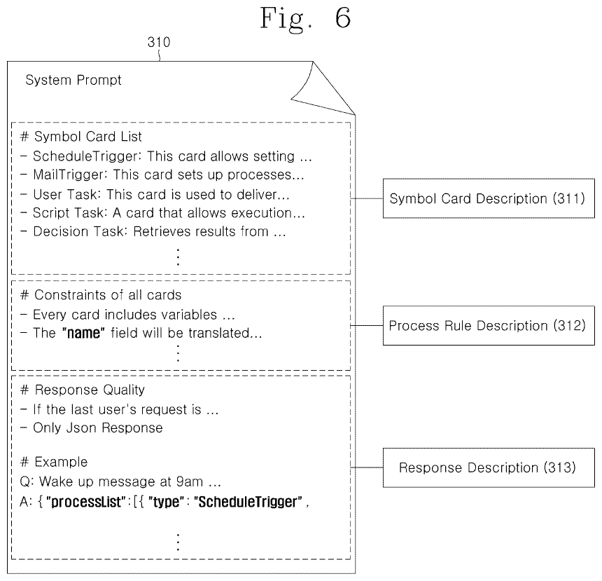

As a more specific example, as shown in FIG. 6, the system prompt 310 may include first information 311 about the types and characteristics of unit elements available for configuring the business process, second information 312 about rules for configuring the business process, based on the one or more unit elements, and third information 313 about the format of a response generated in the artificial intelligence model.

More specifically, the first information 311 may include specifications for symbols through datafication of information about symbols of the business process modeling and notation (BPMN) into a form capable of being processed by the artificial intelligence model such as a large language model (LLM).

In addition, the second information 312 may include rules among the symbols of the business process modeling and notation (BPMN) and rules for the business process configured to include one or more symbols.

Furthermore, the third information 313 may include specifications for response formats of the artificial intelligence model such as a large language model (LLM).

More specifically, the third information 313 may be specified to include the types of the respective symbols constituting the business process for the target business and the connection sequences, such as positions of the respective symbols, in the response of the artificial intelligence model, and may also be specified to include input variables and output variables of the respective symbols and other necessary basic information.

In addition, the third information 313 may be specified to respond in a format such as business process modeling and notation (BPMN) 2.0 XML, and further, may be specified to respond in a simplified format such as JSON in order to reduce response tokens required in the artificial intelligence model such as a large language model (LLM).

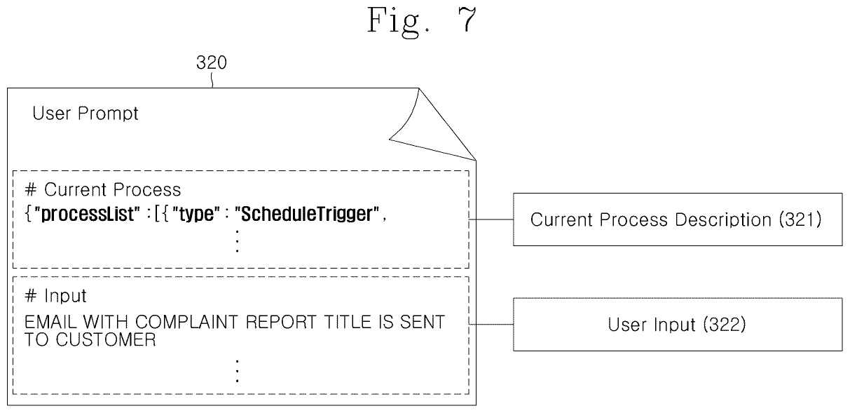

In addition, as shown in FIG. 7, the user prompt 320 may include, when generating the business process by modifying the pre-generated second business process, fourth information 321 obtained by converting the second business process into a data format capable of being processed by the artificial intelligence model and fifth information 322 configured based on the input text.

More specifically, the fourth information 321 may include data obtained by converting the second business process, which was generated through past working or is being generated and modified through current working, into a format capable of being processed by the artificial intelligence model such as a large language model (LLM), and may also include information about connection positions designated by the user as positions where one or more unit elements are added in the second business process.

Accordingly, in the disclosure, the artificial intelligence model, such as a large language model (LLM), may add one or more unit elements to the exact position, instead of repeating the generation of the business process, based on the fourth information 321, thereby efficiently producing the business process.

In addition, the fifth information 322 may be configured to include input text describing the target business in natural language or text produced through post-processing of the input text.

Accordingly, the process auto-generation manager 1221 may configure the first prompt, based on the system prompt 310 and the user prompt 320, and provide it to the artificial intelligence model manager 1222 (\textcircled{2} in FIG. 5).

Next, the artificial intelligence model manager 1222 may manage various artificial intelligence models such as a large language model LLM1 (1231) provided by a third party or a large language model LLM2 (1232) that is being operated independently, and may call an artificial intelligence model selected in consideration of the user settings or operating environment using an application programming interface (API) and receive a response from the artificial intelligence model and transmit it to the process auto-generation manager 1221 (\textcircled{2} in FIG. 5).

Accordingly, in step S120 in FIG. 2, the types of one or more unit elements constituting the business process and connection sequences thereof may be produced using the artificial intelligence model, based on the first prompt.

In this case, the response generated from the artificial intelligence model may include a list of one or more unit elements constituting the business process, and further, the list of one or more unit elements may include information about the types of unit elements and the connection sequences of the unit elements.

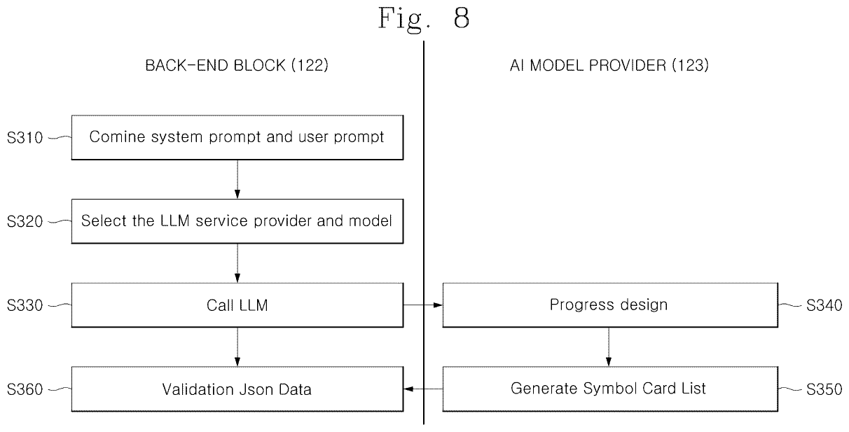

More specifically, as shown in FIG. 8, the process auto-generation manager 1221 of the back-end block 122 may generate the first prompt by combining the system prompt 310 and the user prompt 320 (S310).

Subsequently, the artificial intelligence model manager 1222 of the back-end block 122 may select an artificial intelligence model provider and model, such as a large language model (LLM) (S320), and call the selected artificial intelligence model (S330).

Accordingly, the artificial intelligence model selected by the artificial intelligence model provider 123 may design a business process for performing the target business, based on the first prompt provided from the back-end block 122 (S340), and generate a list of one or more unit elements constituting the business process to provide a response to the back-end block 122 (S350).

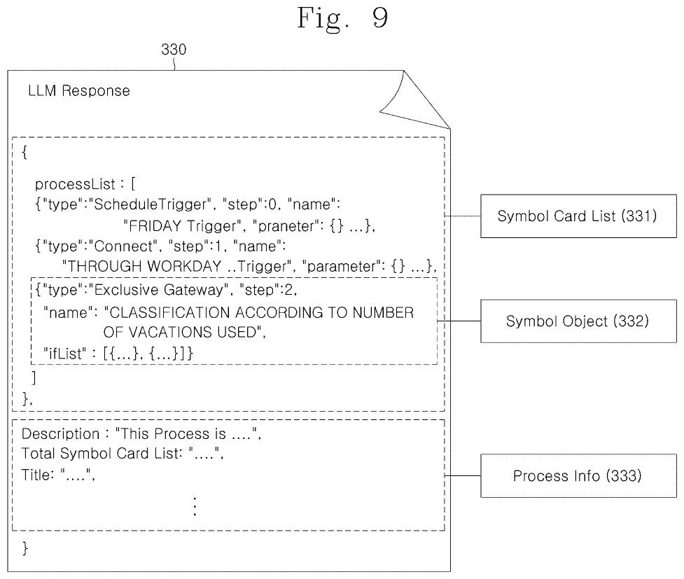

As a more specific example, FIG. 9 illustrates a response 330 generated from the artificial intelligence model.

As shown in FIG. 9, the response 330 of the artificial intelligence model may include a symbol list 331 for unit elements such as symbols constituting the business process, and the symbol list 331 may also include a symbol object 332 that includes information about the types and connection sequences of the symbols.

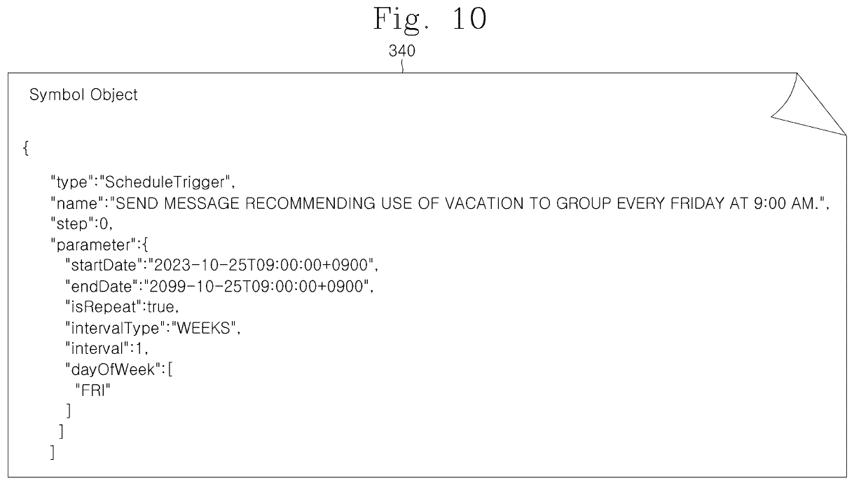

More specifically, as shown in FIG. 10, the symbol object 340 may include the type, name, connection sequences (step), and various parameters of each symbol.

Accordingly, as shown in FIG. 5, the process auto-generation manager 1221 of the back-end block 122 may provide the response of the artificial intelligence model to the process auto-generation request processor 1213 of the front-end block 121 (\textcircled{1} in FIG. 5).

Then, the process auto-generation request processor 1213 may forward the received response of the artificial intelligence model to the process generator 1214 to generate the business process, based on this (\textcircled{3} in FIG. 5).

Accordingly, in step S130 in FIG. 2, the business process corresponding to the target business is generated based on the types and connection sequences of the one or more unit elements.

In this case, in step S130, the business process may be generated by sequentially configuring and adding each unit element, based on the types and connection sequences of the one or more unit elements.

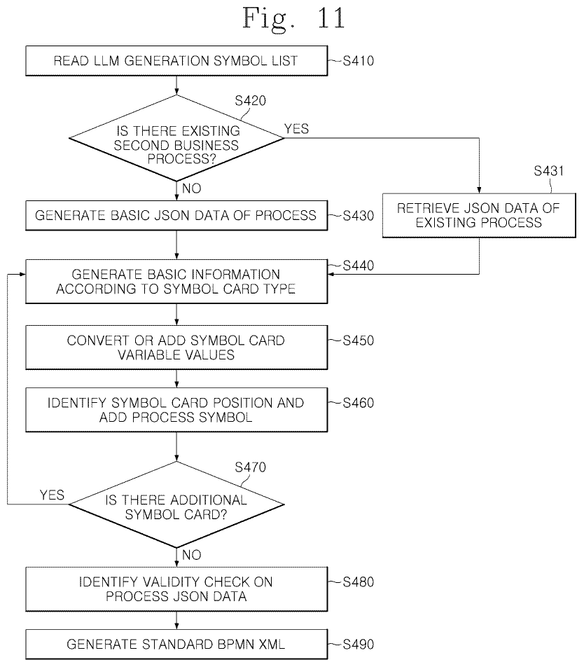

More specifically, as shown in FIG. 11, the process generator 1214 of the front-end block 121 may first read the symbol list 331 from the response 330 generated in the artificial intelligence model such as a large language model (LLM) (S410).

Next, the process generator 1214 may determine whether an existing second business process exists (S420) and, if it does not exist, generate a new business process with a basic structure. In this case, the business process may be configured in a simple JSON format, thereby reducing the number of tokens required for processing in the artificial intelligence model (S430).

On the other hand, if an existing second business process exists, data configured in a JSON format for the second business process may be loaded and used (S431).

Next, the process generator 1214 may generate basic information about the first symbol in the symbol list according to the symbol type (S440), convert or add variable values of the first symbol to configure the symbol (S450), and then identify the connection position to which the first symbol is to be added according to the connection sequences of the first symbol, thereby adding it to the business process (S460).

Next, the process generator 1214 may sequentially perform the process of configuring symbols for the remaining symbols, such as the second symbol, in the symbol list and adding them to the business process.

Accordingly, the process generator 1214 may identify whether all symbols to be added have been completed in the symbol list (S470) and then terminate the generation process of the business process.

In addition, the process generator 1214 may further perform a validity check on the business process generated in JSON format (S480), and may convert the business process generated in JSON format into a document such as XML according to the generated business process modeling and notation (BPMN) and provide it (S490)

Accordingly, as shown in FIG. 5, the process generator 1214 may transmit the generated business process in JSON format or XML format to the output interface 1215, thereby provide it to the user (\textcircled{4} in FIG. 5).

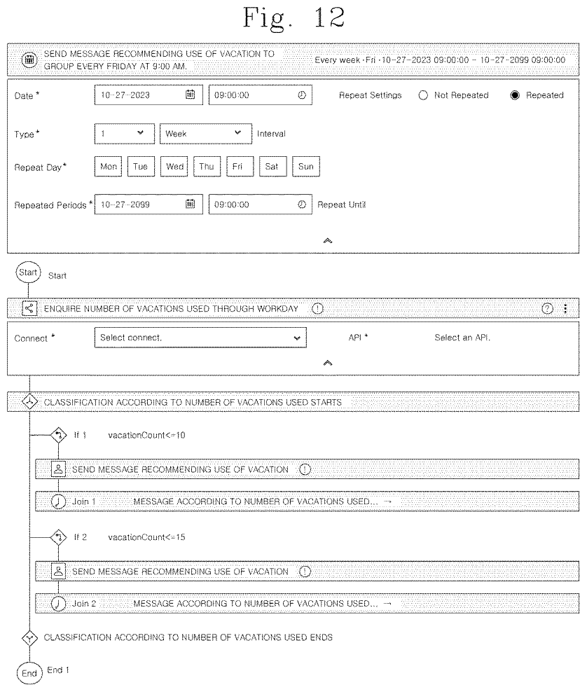

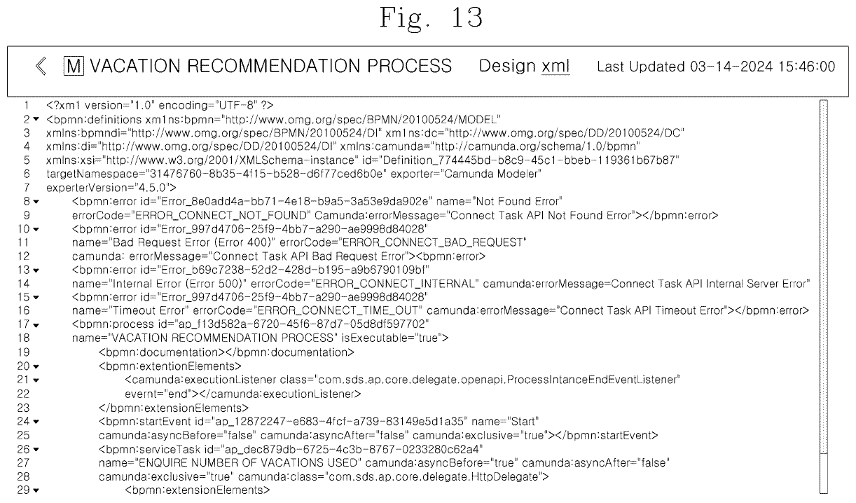

In this regard, FIG. 12 illustrates a screen that provides a business process in the form of a diagram, which is generated in JSON format, based on input text for the vacation recommendation message processing business (target business) in the example in FIG. 3, and FIG. 13 illustrates a screen that converts the business process in FIG. 12 into an XML document based on the business process modeling and notation (BPMN) and provide it.

In addition, the disclosure may display the process in a diagram form to the user and display the further generated symbols to be identified, enabling the user to easily identify which part of the business process was automatically generated, and may further provide a function of retrieving the XML documents based on the business process modeling and notation (BPMN).

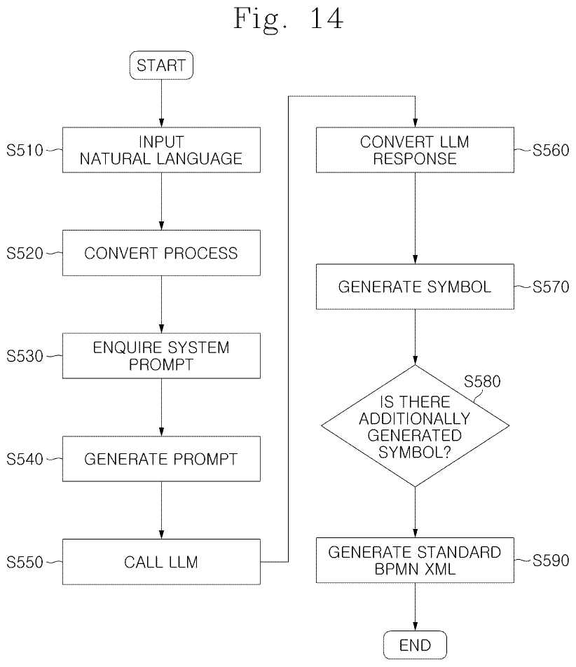

In addition, FIG. 14 is a flowchart specifically illustrating a business process generating method according to an embodiment of the disclosure.

Hereinafter, a specific execution scenario of a business process generating method according to an embodiment of the disclosure will be described with reference to FIG. 14.

First, the business process generating apparatus 120 may receive input text including a description of the target business, which is input by the user in a natural language format for automatic design of the business process (S510).

In this case, if the user generates a business process for the target business, based on the pre-generated second business process, the user may select connection positions to which one or more unit elements are to be added from the second business process, and if the user generates a new business process not based on the second business process, the user may enter input text including a description of the target business to an input window to immediately perform the generation of the business process.

Accordingly, in the case where a business process is generated based on the second business process, the business process generating apparatus 120 may convert the second business process into a data format capable of being processed by the artificial intelligence model (S520).

Subsequently, the business process generating apparatus 120 may enquire the system prompt for automatic generation of the business process (S530), and combine it with the user prompt configured based on the input text and data about the second business process, thereby generating the first prompt (S540).

Accordingly, the business process generating apparatus 120 may call the artificial intelligence model such as a large language model (LLM) using the first prompt (S550), identify and convert a symbol list from the response of the artificial intelligence model such as a large language model (LLM) (S560), and generate unit elements such as symbols constituting the business process (S570).

More specifically, the business process generating apparatus 120 may extract a symbol list from the response of the artificial intelligence model such as a large language model (LLM), and at this time, when generating a business process based on the pre-generated second business process, may read the data (e.g., JSON Data) of the second business process, and when generating a new business process not based on the second business process, may generate and use the basic business process.

At this time, the business process generating apparatus 120 may generate basic information for each symbol according to the type of the symbol, based on the data of each symbol object 331 in the symbol list 330, extract variable values from the symbol list 330, and add the same thereto, thereby generating each symbol.

In addition, the business process generating apparatus 120 may identify the connection sequences (step) of the respective symbols in the symbol list 330 and add it to the business process, and at this time, may configure the business process while sequentially generating all symbols in the symbol list.

Next, the business process generating apparatus 120 may identify whether there are any symbols remaining in the symbol list, which are to be further generated (S580), and then generate a document such as XML according to the business process modeling and notation (BPMN), based on the automatically generated business process to which all symbols are added (S590).

In addition, the business process generating method according to an embodiment of the disclosure may further include a step (not shown) of automatically performing the target business using the business process generated in steps S110 to S130.

Accordingly, if the user provides input text requesting to perform a specific target business specified in natural language, the business process generating apparatus 120 may generate a business process corresponding to the target business, based on the input text, and automatically perform it, thereby enabling the user to perform the target business more conveniently.

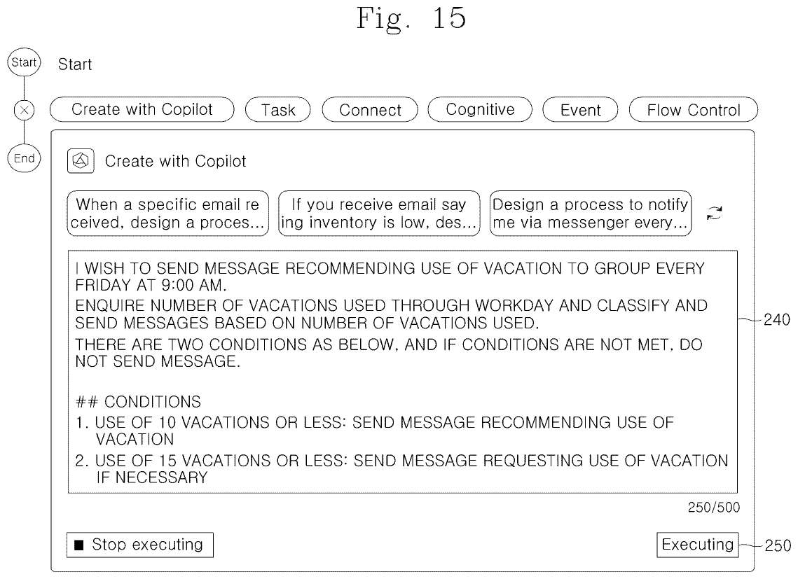

As a more specific example, as shown in FIG. 15, if the user wishes to perform a vacation recommendation message sending business (target business), the user may enter input text 240 describing the target business through a user interface (UI) provided through a user terminal 110 or the like.

In this case, as shown in FIG. 15, the input text 240 may describe the content, conditions, and characteristics of the target business in natural language, but the disclosure is not necessarily limited to this.

Next, the user may generate a business process corresponding to the target business using a target business execution button 250 provided in the user interface (UI), and automatically perform it.

More specifically, the business process generating apparatus 120 may configure a first prompt for generating a business process corresponding to the target business using a system prompt 310 and a user prompt 320, based on the input text 240.

Next, the business process generating apparatus 120 may design a business process corresponding to the target business by producing the types and connection sequences of one or more unit elements constituting the business process using the artificial intelligence model such as a large language model (LLM), based on the first prompt, and further automatically execute the generated business process.

In addition, the business process generating apparatus 120 may provide the user with a visualized result of performing the business process together with the business process, and may provide a diagram (e.g., FIG. 12) of the designed business process before automatically performing the business process, and then perform the business process after the user's confirmation, or provide a menu for adding, deleting, or modifying unit elements in the generated business process.

In addition, a computer program according to another aspect of the disclosure may be a computer program stored in a computer-readable medium for executing a series of steps of the business process generating method in the business process generating system 100 described above in a computer. The computer program may be not only a computer program including machine language codes created by a compiler, but also a computer program including high-level language codes executable in a computer using an interpreter or the like. In this case, the computer includes, in addition to a personal computer (PC) or a laptop computer, any type of information processing device equipped with a central processing unit (CPU) to execute a computer program, such as a server, a smartphone, a tablet PC, a PDA, or a mobile phone.

In addition, the computer-readable medium may be a medium that continuously stores a computer-executable program, or temporarily stores it for execution or download. In addition, the medium may be a variety of recording means or storage means in the form of a single piece of hardware or a combination of multiple pieces of hardware, and may not be limited to a medium directly connected to a computer system, but may also be distributed on a network. Therefore, the above detailed description should not be construed as limiting the disclosure in all respects and should be considered as examples. The scope of the disclosure should be determined by a reasonable interpretation of the appended claims, and all changes within the equivalent scope of the disclosure are included in the scope of the disclosure.

In addition, FIG. 16 illustrates a device 50 to which the proposed method of the disclosure may be applied.

Referring to FIG. 16, the device 50 may be configured to implement a business process generation process in the business process generating system 100 according to the proposed method of the disclosure.

For example, the device 50 to which the proposed method of the disclosure may be applied may include network devices such as repeaters, hubs, bridges, switches, routers, gateways, and the like, computer devices such as desktop computers, workstations, and the like, mobile terminals such as smartphones and the like, portable devices such as laptop computers and the like, home appliances such as digital TVs and the like, and moving means such as vehicles and the like. As another example, the device 50 to which the disclosure may be applied may be included as part of an ASIC (Application Specific Integrated Circuit) implemented in the form of an SoC (System-on-Chip).

The memory 20 may be connected to the processor 10 during operation, and may store programs and/or instructions for processing and controlling the processor 10, and may store data and information used in the disclosure, control information required for processing data and information according to the disclosure, and temporary data generated during the data and information processing process. The memory 20 may be implemented as a storage device such as a ROM (Read-Only Memory), a RAM (Random Access Memory), an EPROM (Erasable Programmable Read-Only Memory), an EEPROM (Electrically Erasable Programmable Read-Only Memory), a flash memory, a SRAM (Static RAM), an HDD (Hard Disk Drive), an SSD (Solid State Drive), and the like.

The processor 10 may be operatively connected to the memory 20 and/or the network interface 30, and may control the operation of respective modules in the device 50. In particular, the processor 10 may perform various control functions for performing the proposed method of the disclosure. The processor 10 may also be called a controller, a micro-controller, a micro-processor, a micro-computer, or the like. The proposed method of the disclosure may be implemented by hardware, firmware, software, or a combination thereof. When implementing the disclosure using hardware, an ASIC (application specific integrated circuit) or a DSP (digital signal processor), a DSPD (digital signal processing device), a PLD (programmable logic device), an FPGA (field programmable gate array), or the like, configured to perform the disclosure, may be provided in the processor 10. Meanwhile, when implementing the proposed method of the disclosure using firmware or software, the firmware or software may include instructions related to modules, procedures, or functions that perform functions or operations necessary for implementing the proposed method of the disclosure, and the instructions may be stored in the memory 20 or stored in a computer-readable recording medium (not shown) separate from the memory 20, and may be configured to cause, when executed by the processor 10, the device 50 to perform the proposed method of the disclosure.

In addition, the device 50 may include a network interface device 30. The network interface device 30 may be connected to the processor 10 during operation, and the processor 10 may control the network interface device 30 to transmit or receive wireless/wired signals carrying information, data, signals, and/or messages through a wireless/wired network. The network interface device 30 may support various communication standards such as IEEE 802 series, 3GPP LTE (−A), 3GPP 5G, etc., and may transmit and receive control information and/or data signals according to the corresponding communication standards. The network interface device 30 may be implemented outside the device 50 as needed.

Accordingly, in the natural language-based business process auto-generation system, method, apparatus, and computer program according to an embodiment of the disclosure, workers are able to efficiently design desired business processes, even if they lack related knowledge and experience, and easily modify a pre-designed business process to generate business processes suitable for them, and furthermore, it is possible to effectively reduce the cost and time required to generate a business process by simplifying the process of designing the business process.

The embodiments described in this specification and the attached drawings are merely exemplary and do not limit the scope of the disclosure in any way. In addition, the connections or connection members between the components illustrated in the drawings are examples of functional connections and/or physical or circuit connections, and may be represented as various functional connections, physical connections, or circuit connections that are replaceable or addible in an actual device. In addition, unless specifically stated with “essential”, “important”, etc., the components may not be essential for the application of the disclosure.

In the specification (especially, in the claims) of the present disclosure, the term “said” and indicative terms similar thereto may be used for both a single element or multiple elements. In addition, if a range is stated in the disclosure, it encompasses embodiments to which respective values within the range are applied (unless otherwise stated), and the respective values constituting the range are regarded as being described in the detailed description of the disclosure. In addition, the steps presented in the method of the disclosure are not intended to be restricted in their sequence, and the sequence thereof may be appropriately changed as needed, unless a certain step must precede according to the nature of the process. All examples or the use of exemplary terms (e.g., etc.) in the disclosure is merely intended to described the disclosure in detail, and the scope of the disclosure is not limited to the examples or exemplary terms, unless limited by the claims. In addition, those skilled in the art will understand that various modifications, combinations, and changes may be configured according to design conditions and elements without departing from the scope of the appended claims or their equivalents.

What is claimed is:

1. A method for generating a business process configured to include one or more unit elements to perform a given target business using a computing device, the method comprising:
configuring a first prompt, based on input text comprising a description of the target business;
producing types and connection sequences of one or more unit elements constituting the business process using an artificial intelligence model, based on the first prompt; and
generating the business process corresponding to the target business, based on the types and connection sequences of the one or more unit elements.

2. The method of claim 1,
wherein, in the configuring of the first prompt,
the first prompt is configured using a system prompt configured to include information about a plurality of types of unit elements and a user prompt configured based on the input text.

3. The method of claim 2,
wherein the system prompt comprises:
first information about the types and characteristics of the unit elements;
second information about rules for configuring the business process, based on the one or more unit elements; and
third information about a format of a response generated in the artificial intelligence model.

4. The method of claim 2,
wherein the user prompt comprises:
fourth information obtained by, in case of generating the business process by modifying a pre-generated second business process, converting the second business process into a data format capable of being processed by the artificial intelligence model; and
fifth information configured based on the input text.

5. The method of claim 4,
wherein the fourth information comprises information about one or more unit elements constituting the second business process, which is converted into a JSON type.

6. The method of claim 4,
wherein, in the configuring of the first prompt, the first prompt is generated by reflecting, together with the input text, input information specifying connection positions to which one or more unit elements are to be added in the second business process, and
wherein, in the generating of the business process, the business process is generated by adding one or more unit elements to the connection positions.

7. The method of claim 1,
wherein, in the producing of the types and connection sequences of the unit elements,
a response generated in the artificial intelligence model comprises a list of one or more unit elements constituting the business process.

8. The method of claim 7,
wherein the list of one or more unit elements comprises information about the types of respective unit elements and the connection sequences of respective unit elements.

9. The method of claim 1,
wherein, in the generating of the business process,
the business process is generated by sequentially configuring and adding each unit element, based on the types and connection sequences of the one or more unit elements.

10. The method of claim 1,
further comprising automatically performing the target business using the generated business process.

11. An apparatus for generating a business process configured to include one or more unit elements to perform a given target business, the apparatus comprising:
a processor; and
a memory,
wherein the memory comprises instructions configured to, when executed by the processor, cause the apparatus to implement specific operations, and
wherein the specific operations comprise:
configuring a first prompt, based on input text comprising a description of the target business;
producing types and connection sequences of one or more unit elements constituting the business process using an artificial intelligence model, based on the first prompt; and
generating the business process corresponding to the target business, based on the types and connection sequences of the one or more unit elements.

12. The apparatus of claim 11,
wherein, in the configuring of the first prompt,
the first prompt is generated using a system prompt configured to include information about a plurality of types of unit elements and a user prompt configured based on the input text.

13. The apparatus of claim 12,
wherein the system prompt comprises:
first information about the types and characteristics of the unit elements;
second information about rules for configuring the business process, based on the one or more unit elements; and
third information about a format of a response generated in the artificial intelligence model.

14. The apparatus of claim 12,
wherein the user prompt comprises:
fourth information obtained by, in case of generating the business process by modifying a pre-generated second business process, converting the second business process into a data format capable of being processed by the artificial intelligence model, and
fifth information configured based on the input text.

15. The apparatus of claim 14,
wherein the fourth information comprises information about one or more unit elements constituting the second business process, which is converted into a JSON type.

16. The apparatus of claim 14,
wherein, in the configuring of the first prompt, the first prompt is generated by reflecting, together with the input text, input information specifying connection positions to which one or more unit elements are to be added in the second business process, and
wherein, in the generating of the business process, the business process is generated by adding one or more unit elements to the connection positions.

17. The apparatus of claim 11,
wherein, in the producing of the types and connection sequences of the unit elements,
a response generated in the artificial intelligence model comprises a list of one or more unit elements constituting the business process.

18. The apparatus of claim 17,
wherein the list of one or more unit elements comprises information about the types of respective unit elements and the connection sequences of respective unit elements.

19. The apparatus of claim 11,
wherein, in the generating of the business process,
the business process is generated by sequentially configuring and adding each unit element, based on the types and connection sequences of the one or more unit elements.

20. A computer-readable storage medium storing instructions configured to, when executed by a processor, cause an apparatus, comprising the processor and generating a business process configured to include one or more unit elements to perform a given target business, to implement specific operations,
wherein the specific operations comprise:
configuring a first prompt, based on input text comprising a description of the target business;
producing types and connection sequences of one or more unit elements constituting the business process using an artificial intelligence model, based on the first prompt; and
generating the business process corresponding to the target business, based on the types and connection sequences of the one or more unit elements.
